(19) United States
(12) Patent Application Publication
(10) Pub. No.: US 2004/0213264 A1
(43) Pub. Date: Oct. 28, 2004

(54) Service class and destination dominance traffic management

(75) Inventors: Nalin Mistry, Nepean (CA); Bradley Venables, Nepean (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 10/636,638

(22) Filed: Aug. 8, 2003

Related U.S. Application Data
(60) Provisional application No. 60/465,265, filed on Apr. 25, 2003.

(51) Int. Cl. H04L 12/56

(52) U.S. Cl. 370/395.7; 370/395.4

(57) ABSTRACT

At the provider edge of a core network, an egress interface may schedule based on a class dominance model, a destination dominance model or a herein-proposed class-destination dominance model. In the latter, queues are organized into sub-divisions, where each of the subdivisions includes a subset of the queues having a per hop behavior in common and at least one of the subsets of the queues is further organized into a group of queues storing protocol data units having a common destination. Scheduling may then be performed on a destination basis first, then a per hop behavior basis. Thus providing user-awareness to a normally user-unaware class dominance scheduling model.

### CROSS REFERENCE TO RELATED APPLICATIONS

The present application claims the benefit of prior provisional application Ser. No. 60/465,265, filed Apr. 25, 2003.

### FIELD OF THE INVENTION

The present invention relates to management of traffic in multi-service data networks and, more particularly, to traffic management that provides for service class dominance and destination dominance.

### BACKGROUND

A provider of data communications services typically provides a customer access to a large data communication network. This access is provided at an “edge node” that connects a customer network to the large data communication network. As such, service providers have a broad range of customers with a broad range of needs, the service providers prefer to charge for their services in a manner consistent with which the services are being used. Such an arrangement also benefits the customer. To this end, a Service Level Agreement (SLA) is typically negotiated between customer and service provider.

According to searchWebServices.com, an SLA is a contract between a network service provider and a customer that specifies, usually in measurable terms, what services the network service provider will furnish. In order to enforce the SLA, these service providers often rely on “traffic management”.

Traffic management involves the inspection of traffic and then the taking of an action based on various characteristics of that traffic. These characteristics may be, for instance, based on whether the traffic is over or under a given rate, or based on some bits in the headers of the traffic (the traffic is assumed to comprise packets or, more generically, protocol data units (PDUs), that each include a header and a payload). Such bits may include a Differentiated Services Code Point (DSCP) or an indication of “IP Precedence”. Although traffic management may be accomplished using a software element, traffic management is presently more commonly accomplished using hardware. Newer technologies are allowing the management of traffic in a combination of hardware and firmware. Such an implementation allows for high performance and high scalability to support thousands of flows and/or connections.

Traffic management may have multiple components, including classification, conditioning, active queue management (AQM) and scheduling.

Exemplary of the classification component of traffic management is Differentiated Services, or “DiffServ”. The DiffServ architecture is described in detail in the Internet Engineering Task Force Request For Comments 2475, published December 1998 and hereby incorporated herein.

In DiffServ, a classifier selects packets based on information in the packet header correlating to pre-configured admission policy rules. There are two primary types of DiffServ classifiers: the Behavior Aggregate (BA) and the Multi-Field (MF). The BA classifier bases its function on the DSCP values in the packet header. The MF classifier classifies packets based on one or more fields in the header, which enables support for more complex resource allocation schemes than the BA classifier offers. These may include marking packets based on source and destination address, source and destination port, and protocol ID, among other variables.

The conditioning component of traffic management may include tasks such as metering, marking, re-marking and policing. Metering involves counting packets that have particular characteristics. Packets may then be marked based on the metering. Where packets have already been marked, say, in an earlier traffic management operation, the metering may require that the packets to be re-marked. Policing relates to the dropping (discarding) of packets based on the metering.

When several flows of data are passing through a network device, it is often the case that the rate at which data is received exceeds the rate at which the data may be transmitted. As such, some of the data received must be held temporarily in queues. Queues represent memory locations where data may be held before being transmitted by the network device. Fair queuing is the name given to queuing techniques that allow each flow passing through a network device to have a fair share of network resources.

The remaining components of traffic management, namely AQM and scheduling, may be distinguished in that AQM algorithms manage the length of packet queues by dropping packets when necessary or appropriate, while scheduling algorithms determine which packet to send next. AQM algorithms may be based on parameters such as a queue size, drop threshold and drop profile. Scheduling algorithms may be configured such that packets are transmitted from a preferred queue more often than from other queues.

Traffic management behavior in place for a particular connection or flow may be known collectively as “per-hop behavior” or PHB. The traffic management that takes place in network elements may then be called PHB treatment of PDUs.

Although current traffic management techniques have adapted well to single service operation, where the single service relates to traffic using, for instance, a Layer 2 technology (protocol) like Asynchronous Transfer Mode (ATM) or a Layer 3 technology like the Internet Protocol (IP), there is a growing requirement for multi-service traffic management. Multi-service traffic management is likely to be required to support a mix of emerging technologies such as Virtual Private Wire Service (VPWS), IP Virtual Private Networks (VPNs), Virtual Private Local Area network (LAN) Services (VPLS) and Broadband Services.

Note that “Layer 2” and “Layer 3” refer to the Data Link layer and the Network Layer, respectively, of the commonly-referenced multi-layered communication model, Open Systems Interconnection (OSI).

While a “common queue” approach to traffic management (the most prevalent model used today) has been seen to be effective in a point to point service scenario, the common queue approach is unlikely to be adopted in an any-to-any service scenario (e.g., IP VPN and VPLS). In particular, the common queue approach lacks VPN separation.

### SUMMARY

By using a class and destination dominance traffic management model, increased user awareness in traffic management is provided at a Provider Edge (PE) node in a multi-service core network. In the class and destination dominance traffic management model, queues are organized into sub-divisions, where each of the subdivisions includes a subset of the queues storing protocol data units having a per hop behavior in common and at least one of the subsets of the queues is further organized into a group of queues storing protocol data units having a common destination. Scheduling may then be performed on a destination basis first, then a per hop behavior basis. Thus providing user-awareness to a normally user-unaware class dominance scheduling model.

In accordance with an aspect of the present invention there is provided a method of scheduling protocol data units stored in a plurality of queues, where the plurality of queues are organized into sub-divisions, each of the subdivisions comprising a subset of the plurality of queues storing protocol data units having a per hop behavior in common. The method includes further subdividing at least one of the subsets of the queues into (i) a group of queues storing protocol data units having a common destination and (ii) at least one further queue storing protocol data units having a differing destination; scheduling the protocol data units from the group of queues to produce an initial scheduling output; and scheduling the protocol data units from the initial scheduling output along with the protocol data units from the at least one further queue.

In accordance with another aspect of the present invention there is provided an egress interface including a plurality of queues storing protocol data units, where the plurality of queues are organized into sub-divisions, each of the subdivisions comprising a subset of the plurality of queues having a per hop behavior in common. The egress interface includes a first scheduler adapted to produce an initial scheduling output including protocol data units having a common destination, where the protocol data units having the common destination are stored in a subdivision of the plurality of queues, and a second scheduler adapted to schedule the protocol data units from the initial scheduling output along with protocol data units from at least one further queue, where the protocol data units from the at least one further queue have a destination different from the common destination and the protocol data units from the at least one further queue share per hop behavior with the protocol data units from the initial scheduling output.

In accordance with a further aspect of the present invention there is provided an egress interface including a plurality of queues storing protocol data units, where the plurality of queues are organized into sub-divisions, each of the subdivisions comprising a subset of the plurality of queues having a per hop behavior in common. The egress interface includes a first scheduler adapted to produce an initial scheduling output including protocol data units having a common destination, where the protocol data units having the common destination are stored in a subdivision of the plurality of queues and a second scheduler adapted to schedule the protocol data units from the initial scheduling output along with protocol data units from at least one further queue, where the protocol data units from the at least one further queue have a destination different from the common destination and the protocol data units from the at least one further queue are predetermined to share a given partition of bandwidth available on a channel with the protocol data units from the initial scheduling output.

In accordance with a still further aspect of the present invention there is provided a computer readable medium containing computer-executable instructions which, when performed by processor in an egress interface storing protocol data units in a plurality of queues, where the plurality of queues are organized into subdivisions, each of the subdivisions comprising a subset of the plurality of queues having a per hop behavior in common, cause the processor to: subdivide at least one of the subsets of the queues into a group of queues storing protocol data units having a common destination and at least one further queue storing protocol data units having a differing destination; schedule the protocol data units from the group of queues to produce an initial scheduling output; and schedule the protocol data units from the initial scheduling output along with the protocol data units from the at least one further queue.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a connection between customer networks and provider edge nodes in a core network;

FIG. 2 illustrates a provider edge node of FIG. 1 in detail that includes interfaces with one of the customer networks and with the core network according to an embodiment of the present invention;

FIG. 3 illustrates a class dominance model for scheduling at one of the interfaces of the provider edge node of FIG. 2;

FIG. 4 illustrates a class-destination dominance model for scheduling at one of the interfaces of the provider edge node of FIG. 2 according to an embodiment of the present invention;

FIG. 5 illustrates a series of drop thresholds associated with a queue in the model of FIG. 4 according to an embodiment of the present invention;

FIG. 6 illustrates a class-destination dominance model for scheduling at another one of the interfaces of the provider edge node of FIG. 2 according to an embodiment of the present invention; and

FIG. 7 illustrates an alternative class-destination dominance model to the model of FIG. 6 for same interface according to an embodiment of the present invention.

### DETAILED DESCRIPTION

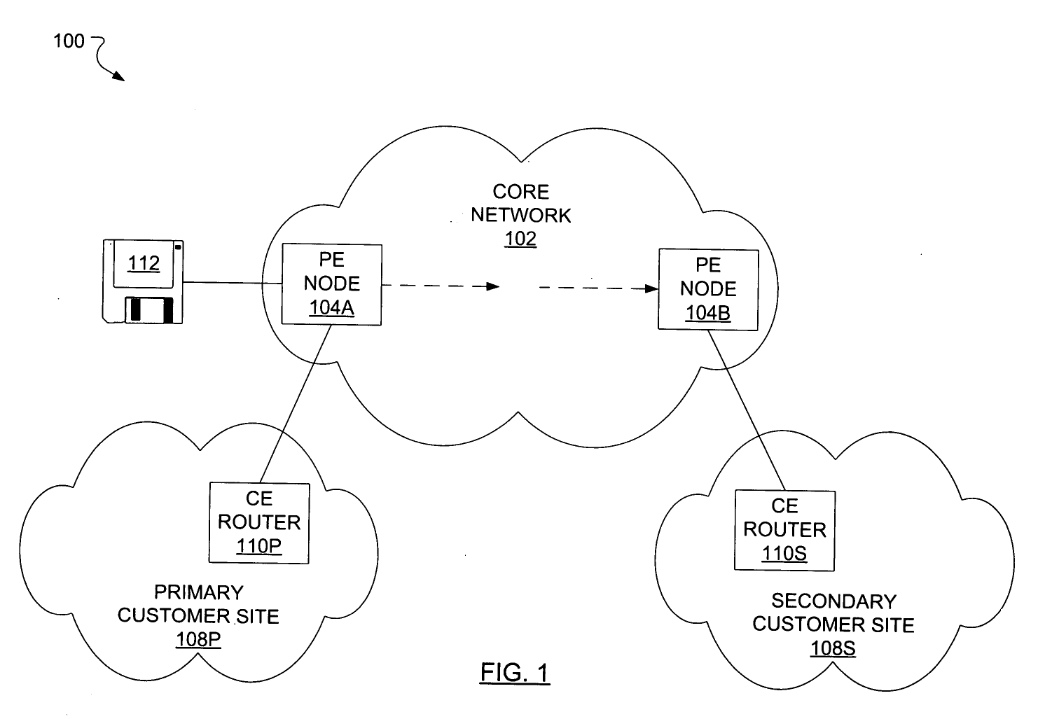

A simplified network 100 is illustrated in FIG. 1 wherein a core network 102 is used by a service provider to connect a primary customer site 108P to a secondary customer site 108S (collectively or individually 108). A customer edge (CE) router 110P at the primary customer site 108P is connected to a first provider edge (PE) node 104A in the core network 102. Further, a second CE router 110S, at the secondary customer site 108S, is connected to a second PE node 104B in the core network 102. (PE nodes may be referred to individually or collectively as 104. Similarly, CE routers may be referred to individually or collectively as 110).

The first PE node 104A may be loaded with traffic management software for executing methods exemplary of this invention from a software medium 112 which could be a disk, a tape, a chip or a random access memory containing a file downloaded from a remote source.

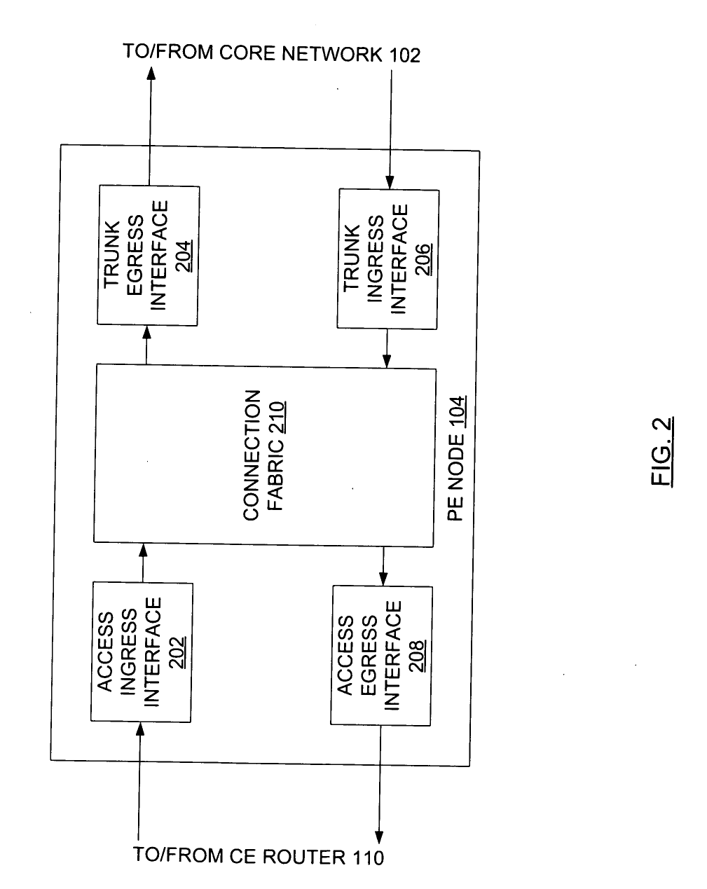

Components of a typical PE node 104 are illustrated in FIG. 2. The typical PE node 104 includes interfaces for communication both with the CE routers 110 and with nodes within the core network 102. In particular, an access ingress interface 202 is provided for receiving traffic from the CE router 110. The access ingress interface 202 connects, and passes received traffic, to a connection fabric 210. A trunk egress interface 204 is provided for transmitting traffic received from the connection fabric 210 to nodes within the core network 102. A trunk ingress interface 206 is provided for receiving traffic from nodes within the core network 102 and passing the traffic to the connection fabric 210 from which an access egress interface 208 receives traffic and transmits the received traffic to the CE router 110.

Particular aspects of traffic management are performed at each of the components of the typical PE node 104. For instance, the access ingress interface 202 performs classification and conditioning. The trunk egress interface 204 performs classification, conditioning, queuing and scheduling, which may include shaping and AQM. The trunk ingress interface 206 performs classification and conditioning. The access egress interface 208 performs classification, conditioning, queuing and scheduling, which may include shaping and AQM.

In the following, it assumed that the core network 102 is an IP network employing Multi-Protocol Label Switching (MPLS). As will be understood by those skilled in the art, the present invention is not intended to be limited such cases. An IP/MPLS core network 102 is simply exemplary.

MPLS is a technology for speeding up network traffic flow and increasing the ease with which network traffic flow is managed. A path between a given source node and a destination node may be predetermined at the source node. The nodes along the predetermined path are then informed of the next node in the path through a message sent by the source node to each node in the predetermined path. Each node in the path associates a label with a mapping of output to the next node in the path. By including, at the source node, the label in each PDU sent to the destination node, time is saved that would be otherwise needed for a node to determine the address of the next node to which to forward a PDU. The path arranged in this way is called a Label Switched Path (LSP). MPLS is called multiprotocol because it works with the Internet Protocol (IP), Asynchronous Transport Mode (ATM) and frame relay network protocols. An overview of Multi Protocol Label Switching (MPLS) is provided in R. Callon, et al, “A Framework for Multiprotocol Label Switching” , Work in Progress, November 1997, and a proposed architecture is provided in E. Rosen, et al, “Multiprotocol Label Switching Architecture” , Work in Progress, July 1998, both of which are hereby incorporated herein by reference.

Using MPLS, two Label Switching Routers (LSRs) must agree on the meaning of the labels used to forward traffic between and through each other. This common understanding is achieved by using a set of procedures, called a label distribution protocol, by which one LSR informs another of label bindings it has made. The MPLS architecture does not assume a specific label distribution protocol (LDP). An LSR using an LDP associates a Forwarding Equivalence Class (FEC) with each LSP it creates. The FEC associated with a particular LSP identifies the PDUs which are “mapped” to the particular LSP. LSPs are extended through a network as each LSR “splices” incoming labels for a given FEC to the outgoing label assigned to the next hop for the given FEC.

MPLS supports carrying DiffServ information through two ways on Label Switched Paths, namely Label-inferred-LSPs (L-LSP) and EXP-inferred-LSPs (E-LSP). An L-LSP is intended to carry a single Ordered Aggregate (OA—a set of behavior aggregates sharing an ordered constraint) per LSP. In an L-LSP, PHB treatment is inferred from the label. An E-LSP allows multiple OAs to be carried on single LSP. In an E-LSP, EXP bits in the label indicate required PHB treatment.

In MPLS, a Label Switching Router (LSR) may create a Traffic Engineering Label Switched Path (TE-LSP) by aggregating LSPs in a hierarchy of such LSPs.

There exist multiple models for queue scheduling including, for example, a class dominance model and a destination dominance model.

In the class dominance model, class fairness is provided across a physical port. That is, at the port, or channel, level, scheduling is based on the service class of the incoming PDUs. The service class refers to the priority of the data. Thus, high priority data is scheduled before low priority data. From a traffic management perspective, there is no awareness of Label Switched Paths (LPSs). The class dominance model is appropriate for an LSP established using LDP in downstream unsolicited (DU) mode, wherein a downstream router distributes unsolicited labels upstream.

In the destination dominance model, each destination is associated with a particular LSP. The destination dominance model provides class fairness within a LSP, however, the fairness does not extend across a channel. That is, for each LSP, scheduling is based on the service class of the incoming PDUs. PDUs may be sent on many LSPs within a single channel. The destination dominance model is seen as suitable for a traffic engineered LSP.

Note that an LSP may extend from the first PE node 104A to the second PE node 104B in the core network 102. Alternatively, an LSP may only extend part way into the core network 102 and terminate at a particular core network node. The packets may then be sent on to their respective destinations from that particular core network node using other networking protocols. However, from the perspective of a trunk egress interface in the first PE node 104A, the packets that share a particular LSP have a “common destination” and may be treated differently, as will be explained further hereinafter.

In overview, it is proposed herein to combine the class dominance model and the destination dominance model into a combination class-destination dominance model. The class-destination dominance model may be used in scheduling at the trunk egress interface 204 and the access egress interface 208.

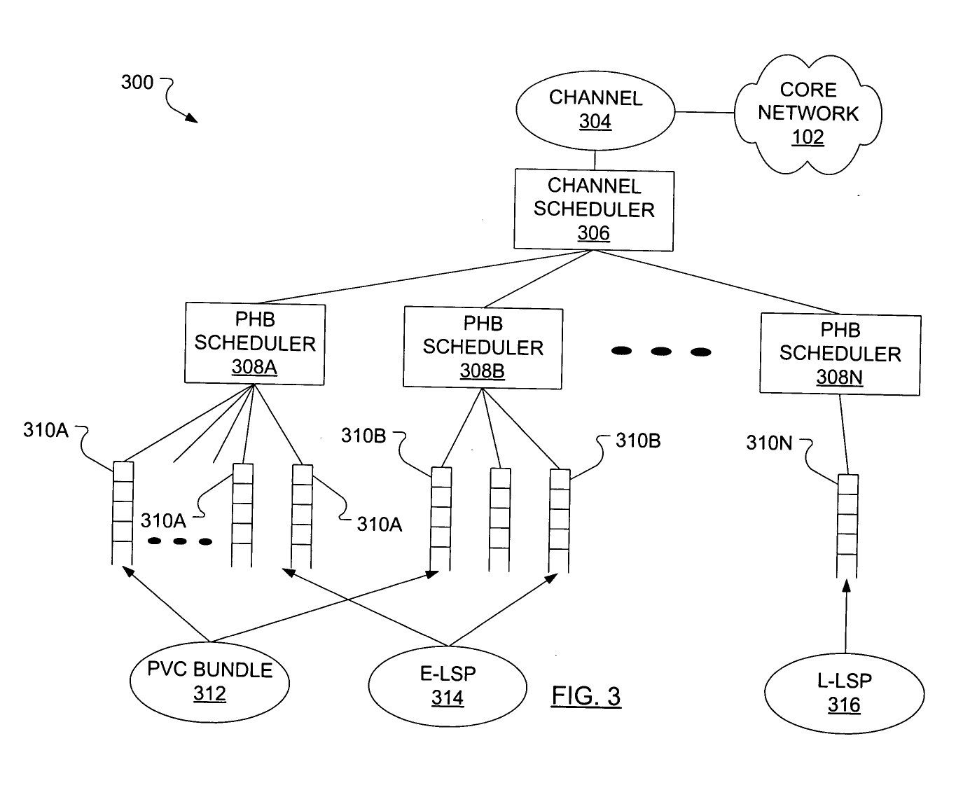

A class dominance model 300 for the typical operation of the trunk egress interface 204 may be explored in view of FIG. 3. The trunk egress interface 204 manages traffic that is to be transmitted on a single channel 304 within the core network 102. A channel scheduler 306 arranges transmission of packets received from a set of PHB schedulers including a first PHB scheduler 308A, a second PHB scheduler 308B, . . . , and an nth PHB scheduler 308N (collectively or individually 308). A given PHB scheduler 308 schedules transmission of packets arranged in queues 310 particular to the class served by the given PHB scheduler 308. In particular, FIG. 3 illustrates multiple queues 310A of a first class, multiple queues 310B of a second class and a single queue 310N of a third class, where it is understood that many more classes may be scheduled. The packets (or, more generally, PDUs) may arrive at the trunk egress interface 204 as part of many different types of connections. The connection types may include, for instance, an ATM permanent virtual circuit (PVC) bundle 312, an E-LSP 314 or an L-LSP 316.

The queues may be divided according to type, where queue types may include, for instance, transport queues, service queues, VPN queues and connection queues. According to the transport queue type, a single queue may be provisioned for each transport technology. Exemplary transport technologies includes ATM, Frame Relay, Ethernet, IP, Broadband, VPLS and Internet Access. According to the service queue type, a single queue may be provisioned for each “Service Definition”. Queues of this type are transparent of the underlying transport technology. Multiple “Service Definitions” may be defined in a single SLA. In the VPN queue type, a single queue may be provisioned for every VPN. In the connection queue type, a single queue may be provisioned for every ATM virtual circuit (VC).

Note that an E-LSP or a PVC bundle may be associated with multiple queues, while an L-LSP is associated with only a single queue.

Overall, it may be considered that the queues serviced by the first PHB scheduler 308A may store packets that have been arranged to receive a “gold” class of service. Additionally, it may be considered that the queues serviced by the second PHB scheduler 308B through the nth PHB scheduler 308N may store packets that have been arranged to receive a “silver” class of service.

The scheduling of the transmission of the packets in the various queues 310 by the PHB schedulers 308 may be accomplished using one of a wide variety of scheduling algorithms. It is contemplated, for the sake of this example, that the first PHB scheduler 308A and the second PHB scheduler 308B employ a scheduling algorithm of the type called “weighted fair queuing” or WFQ. The nth PHB scheduler 310N need not schedule, as only a single queue 310N is being serviced.

The scheduling output of the PHB schedulers 308 may be considered to be queued such that the transmission of the queued scheduling outputs may then be scheduled by the channel scheduler 306. As the scheduling output of the first PHB scheduler 308A is to receive a “gold” class of service, the channel scheduler 306 may schedule the scheduling output of the first PHB scheduler 308A using a “strict priority” scheduling algorithm. In a strict priority scheduling algorithm, delay-sensitive data such as voice is dequeued and transmitted first (before packets in other queues are dequeued), giving delay-sensitive data preferential treatment over other traffic. This strict priority (SP) scheduling algorithm may be combined, at the channel scheduler 306, with a WFQ scheduling algorithm for scheduling the transmission of scheduling output of the other PHB schedulers 308B, . . . , 308N when there is no scheduling output from the first PHB scheduler 308A.

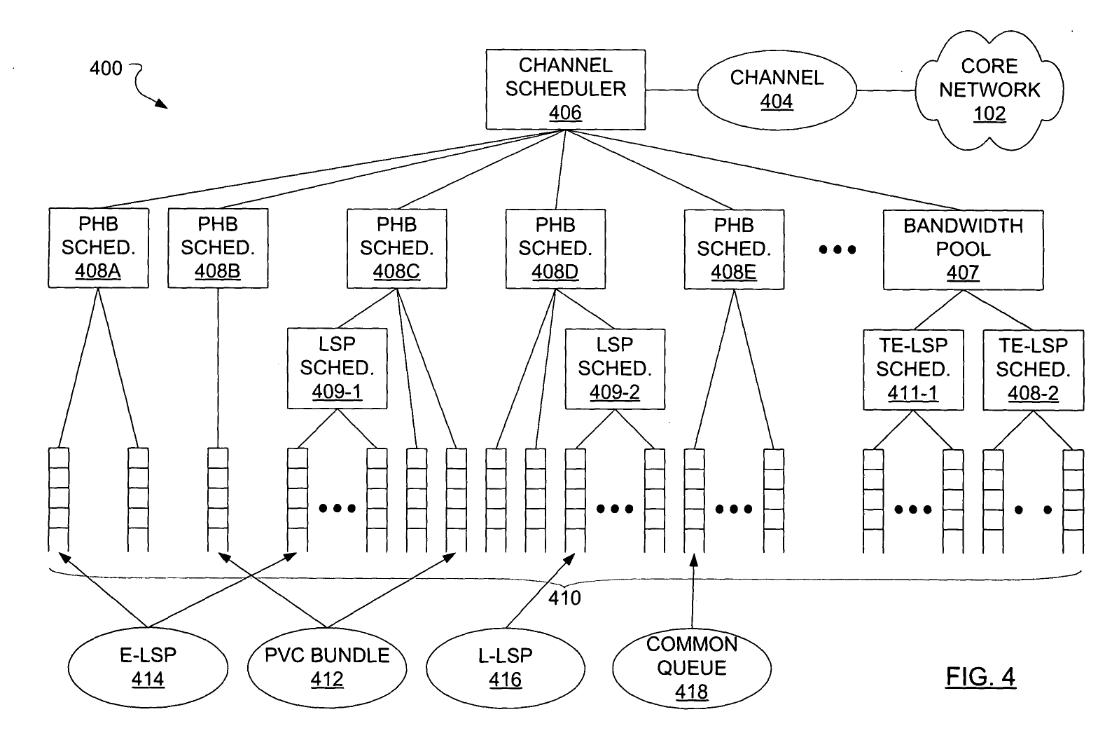

A class-destination dominance model for operation of the trunk egress interface 204 may be explored in view of FIG. 4. The trunk egress interface 204 manages traffic that is to be transmitted on a single channel 404 within the core network 102. A channel scheduler 406 arranges transmission of packets received from a set of PHB schedulers including a first PHB scheduler 408A, a second PHB scheduler 408B, a third PHB scheduler 408C, a fourth PHB scheduler 408D, a fifth PHB scheduler 408E (collectively or individually 408) and a bandwidth pool 407. As in the class dominance model, some PHB schedulers 408 (see, for instance, the first PHB scheduler 408A, the second PHB scheduler 408B and the fifth PHB scheduler 408E) schedule transmission of packets directly from queues 410 particular to the class served by the PHB scheduler 408. However, in contrast to the class dominance model, the class-destination dominance model includes intermediate schedulers that provide an additional level of scheduling.

In particular, a first LSP scheduler 409-1 schedules packets that are to be transmitted on a first LSP to a first destination. The third PHB scheduler 408C then schedules the scheduling output of the first LSP scheduler 409-1 along with packets in a number of other, related queues (i.e., queue in the same service PHB). Similarly, a second LSP scheduler 409-2 schedules packets that are to be transmitted on a second LSP to a second destination. The fourth PHB scheduler 408D then schedules the scheduling output of the second LSP scheduler 409-2 along with packets in a number of other, related queues. As illustrated in FIG. 4, an additional level of scheduling allows for the association of queues within a given service class with each other based on a common destination.

The packets may arrive at the trunk egress interface 204 as part of many different types of connections. The connection types may include, for instance, an ATM PVC bundle 412, an E-LSP 414, an L-LSP 416 or a common queue 418.

The bandwidth pool 407 may be seen as a destination dominant scheduler that schedules to fill a fixed portion of bandwidth on the channel 404. A first TE-LSP scheduler 411-1 schedules packets that are to be transmitted on a first TE-LSP to a given destination. Similarly, a second TE-LSP scheduler 411-2 schedules packets that are to be transmitted on a second TE-LSP to another destination. The bandwidth pool 407 then schedules the scheduling output of the first TE-LSP scheduler 411-1 and the second LSP scheduler 409-2.

The channel scheduler 406 schedules the transmission of the scheduling output of each of the PHB schedulers 408 on the channel 404. The scheduling output of the first PHB scheduler 408A and the second PHB scheduler 408B may be scheduled according to the SP scheduling algorithm, the rest of the PHB schedulers 408 may be scheduled according to the WFQ scheduling algorithm.

As discussed briefly hereinbefore, traffic management may include active queue management (AQM). At the trunk egress interface 204, the queues 410 (FIG. 4) may be managed based on parameters such as a queue size, drop threshold and drop profile.

As the queue 410 is maintained in a block of memory, the size (i.e., the length) of the queue 410 may be configurable to match the conditions in which the queue 410 will be employed.

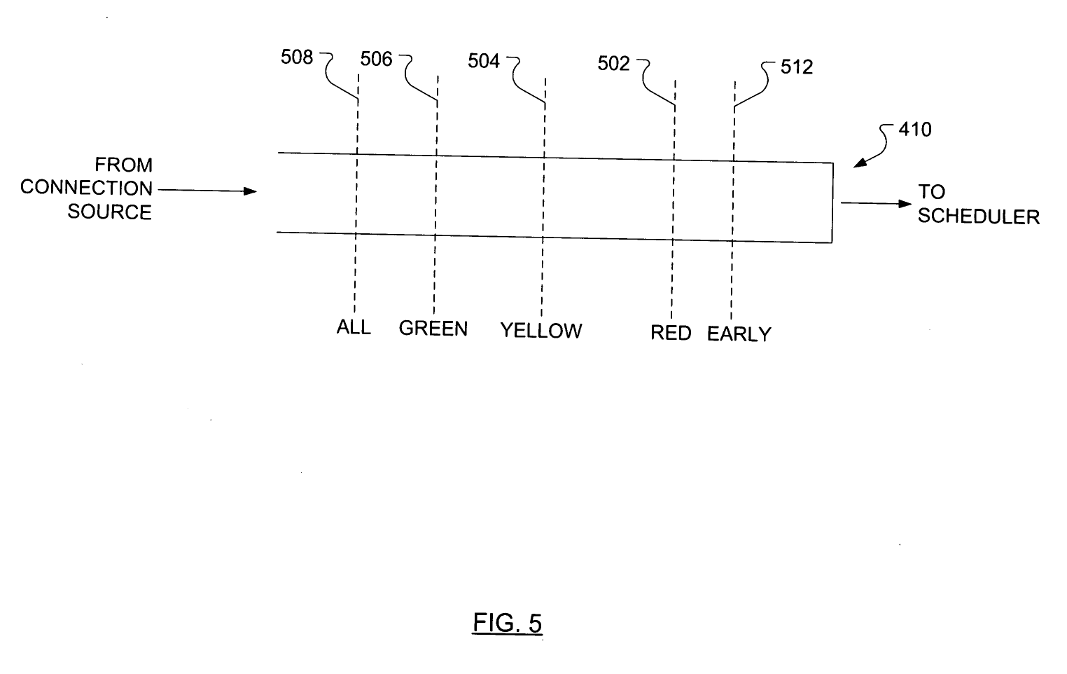

An exemplary one of the queues 410 of FIG. 4 is illustrated in FIG. 5. Four drop thresholds are also illustrated, including a red drop threshold 502, a yellow drop threshold 504, a green drop threshold 506 and an all drop threshold 508.

As mentioned hereinbefore, the conditioning component of traffic management may include the marking of packets. Such marking may be useful in AQM. For instance, the packets determined to be of least value may be marked “red” and the packets determined to be of greatest value may be marked “green” and those packets with intermediate value may be marked “yellow”. Depending on the rate at which packets arrive at the queue 410 of FIG. 5 and the rate at which the packets are scheduled and transmitted from the queue 410, the queue 410 may begin to fill. The AQM system associated with the queue 410 may start discarding packets marked RED once the number of packets in the queue 410 surpasses the red drop threshold 502. Then, as long as the queue 410 stores more packets than the number of packets indicated by the red drop threshold 502, all packets marked RED are discarded. Additionally, the packets marked YELLOW may be discarded as long as the number of packets in the queue 410 is greater than the yellow drop threshold 504, along with the packets marked RED. Similarly, when the number of packets in the queue 410 is greater than the green drop threshold 506, packets marked GREEN may be discarded, along with the packets marked RED and YELLOW. Packets may be discarded irrespective of the marking once the number of packets in the queue 410 is greater than the all drop threshold 508. An additional early drop threshold 512 may also be configured so that the AQM system associated with the queue 410 may start discarding particular ones of the packets marked RED above the red drop threshold 502. The particular ones of the packets marked RED that are discarded are those that have a predetermined set of characteristics.

The precise value of the various drop thresholds (e.g., number of packets) may be configurable as part of a “drop profile”. A particular implementation of AQM may have multiple drop profiles. For example, three drop profiles may extend along a spectrum from most aggressive to least aggressive. Where the queues are divided according to transport service type, different drop profiles may be associated with frame relay queues as opposed to, for instance, ATM queues and Ethernet queues.

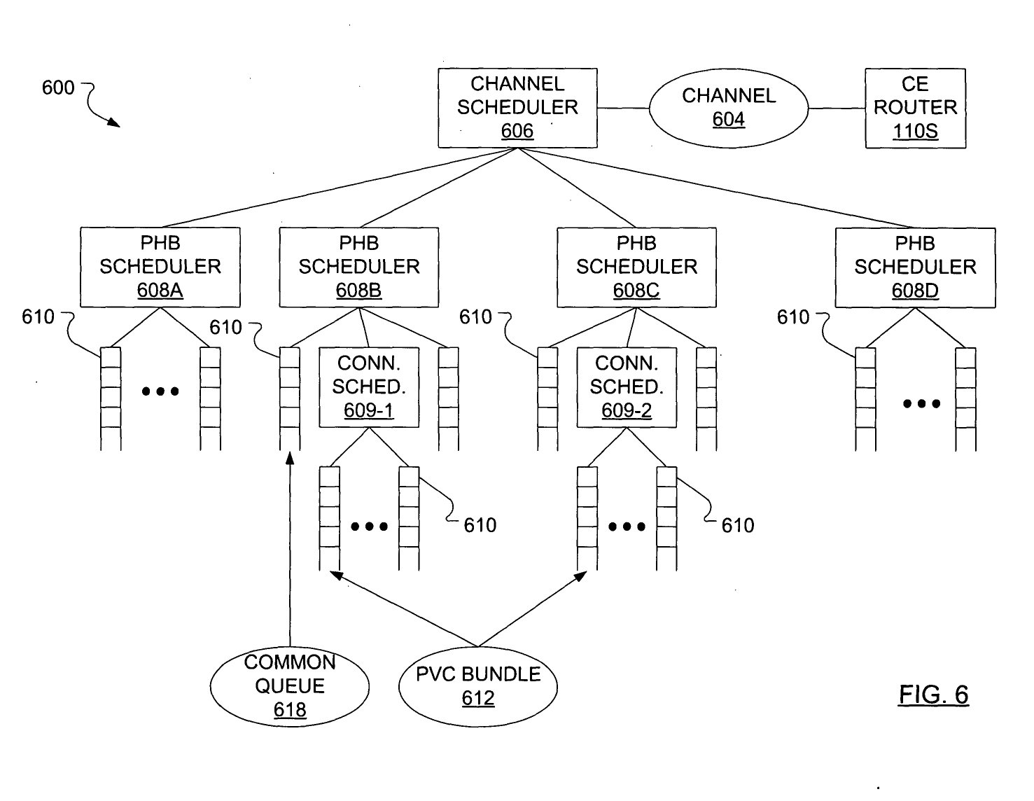

The class-destination dominance model as applied to the operation of the access egress interface 208 may be explored in view of FIG. 6. The access egress interface 208 manages traffic that is to be transmitted on a single channel 604 to the second CE router 110S in the secondary customer site 108S (FIG. 1). A channel scheduler 606 arranges transmission of packets received from a set of PHB schedulers including a first PHB scheduler 608A, a second PHB scheduler 608B, a third PHB scheduler 608C and a fourth PHB scheduler 608D (collectively or individually 608). As in the trunk egress interface 204, some PHB schedulers 608 schedule transmission of packets directly from queues 610 particular to the class served by the PHB scheduler 608. The intermediate schedulers that provide an additional level of scheduling in the access egress interface 208 are a first connection scheduler 609-1 and a second connection scheduler 609-2 (collectively or individually 609).

The packets may arrive at the access egress interface 208 as part of types of connections including an ATM PVC bundle 612 and common queue 618. The packets in the PVC bundle 612 may be divided among the queues according to class of service. The transmission of these packets is then scheduled by one of the connection schedulers 609. Packets arriving from the common queue 618 may be received in a single queue and subsequently scheduled by one of the PHB schedulers 608. In the example illustrated in FIG. 6, the second PHB scheduler schedules packets received from the common queue 618.

The channel scheduler 606 schedules the transmission of the scheduling output of each of the PHB schedulers 608 on the channel 604.

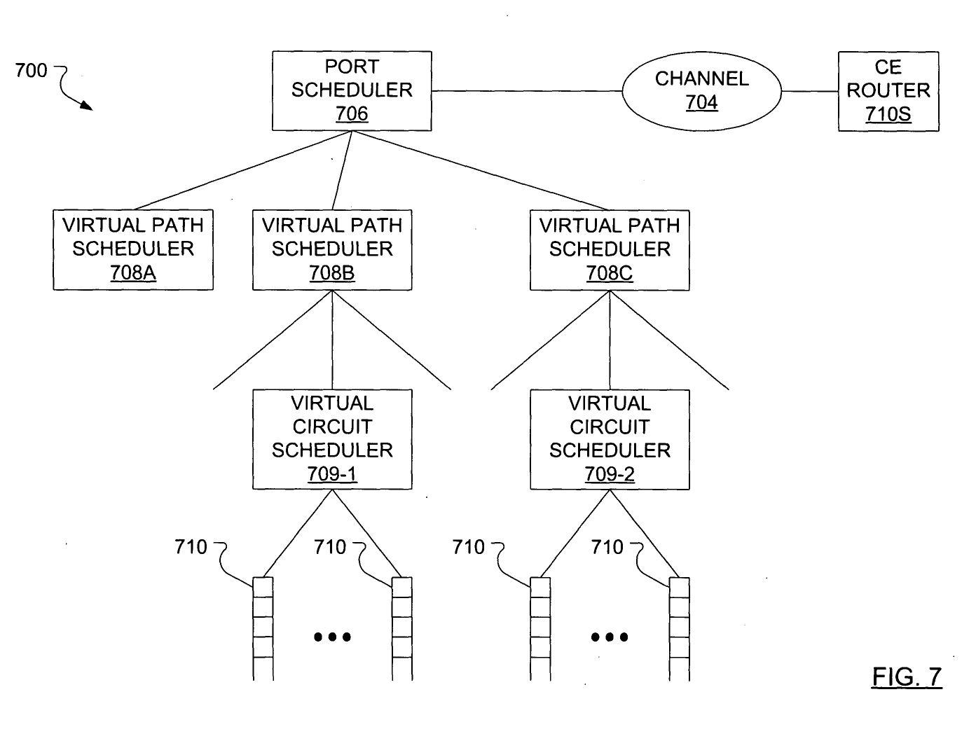

An alternative class-destination dominance model is illustrated, as applied to the operation of the access egress interface 208, in FIG. 7. The access egress interface 208 manages traffic that is to be transmitted on a single channel 704 to the second CE router 110S in the secondary customer site 108S (FIG. 1). A port scheduler 706 arranges transmission of packets received from a set of virtual path schedulers including a first virtual path scheduler 708A, a second virtual path scheduler 708B and a third virtual path scheduler 708C (collectively or individually 708). The intermediate schedulers that provide an additional level of scheduling in this alternative class-destination dominance model for the access egress interface 208 are a first virtual circuit scheduler 709-1 and a second virtual circuit scheduler 709-2 (collectively or individually 709).

Transmission of packets in each of two sets of queues 710 is then scheduled by an associated one of the virtual circuit schedulers 709. In turn, each virtual path scheduler 708 schedules the transmission of the scheduling output of associated ones of the virtual circuit schedulers 709. The port scheduler 706 then schedules transmission of the scheduling output of the virtual path schedulers 708 on the channel 704 to the second CE router 110S.

As will be appreciated by a person of ordinary skill in the art, some per hop behavior traffic management may be performed at individual queues.

Advantageously, the service class and destination dominance traffic management model proposed herein allows for traffic management of multi-service traffic at a PE node in a core network.

Other modifications will be apparent to those skilled in the art and, therefore, the invention is defined in the claims.

We claim:

1. A method of scheduling protocol data units stored in a plurality of queues, where said plurality of queues are organized into sub-divisions, each of said subdivisions comprising a subset of said plurality of queues storing protocol data units having a per hop behavior in common, said method comprising:
further subdividing at least one of said subsets of said queues into (i) a group of queues storing protocol data units having a common destination and (ii) at least one further queue storing protocol data units having a differing destination;
scheduling said protocol data units from said group of queues to produce an initial scheduling output; and
scheduling said protocol data units from said initial scheduling output along with said protocol data units from said at least one further queue.

2. The method of claim 1 wherein said protocol data unit conforms to an Open Systems Interconnection layer 2 protocol.

3. The method of claim 2 wherein said layer 2 protocol is Asynchronous Transfer Mode.

4. The method of claim 2 wherein said layer 2 protocol is Ethernet.

5. The method of claim 1 wherein said protocol data unit conforms to an Open Systems Interconnection layer 3 protocol.

6. The method of claim 5 wherein said layer 3 protocol is the Internet protocol.

7. The method of claim 1 wherein said protocol data units having said common destination share a label switched path in a multi-protocol label switching network.

8. The method of claim 7 wherein said label switched path is a traffic engineering label switched path.

9. The method of claim 1 wherein said protocol data units having said common destination share a virtual circuit in an asynchronous transfer mode network.

10. The method of claim 9 wherein said protocol data units having a per hop behavior in common share a virtual path in said asynchronous transfer mode network.

11. The method of claim 1 wherein said protocol data units having said common destination have an asynchronous transfer mode permanent virtual circuit in common.

12. The method of claim 1 wherein a given one of said plurality of queues is subject to active queue management.

13. The method of claim 1 wherein said sub-divisions into which said plurality of queues are organized are based on service type.

14. The method of claim 1 wherein said sub-divisions into which said plurality of queues are organized are based on transport type.

15. The method of claim 1 wherein said sub-divisions into which said plurality of queues are organized are based on application type.

16. The method of claim 1 wherein a given queue provides per hop behavior traffic management.

17. The method of claim 1 1 wherein said active queue management comprises discarding protocol data units with a first marking as long as said given one of said plurality of queues stores more than a first threshold of protocol data units.

18. The method of claim 17 wherein said active queue management comprises discarding protocol data units with a second marking as long as said given one of said plurality of queues stores more than a second threshold of protocol data units.

19. The method of claim 18 wherein said active queue management comprises discarding protocol data units with a third marking as long as said given one of said plurality of queues stores more than a third threshold of protocol data units.

20. The method of claim 19 wherein said active queue management comprises discarding all protocol data units as long as said given one of said plurality of queues stores more than a fourth threshold of protocol data units.

21. The method of claim 20 wherein said first threshold, second threshold, third threshold and fourth threshold are defined in a drop profile.

22. The method of claim 21 wherein said drop profile is associated with a particular service type.

23. The method of claim 22 wherein said drop profile is a first drop profile and a second drop profile defines a further set of thresholds.

24. The method of claim 23 wherein said second drop profile is associated with a particular transport type.

25. An egress interface including a plurality of queues storing protocol data units, where said plurality of queues are organized into sub-divisions, each of said subdivisions comprising a subset of said plurality of queues having a per hop behavior in common, said egress interface comprising:
a first scheduler adapted to produce an initial scheduling output including protocol data units having a common destination, where said protocol data units having said common destination are stored in a subdivision of said plurality of queues; and
a second scheduler adapted to schedule said protocol data units from said initial scheduling output along with protocol data units from at least one further queue, where said protocol data units from said at least one further queue have a destination different from said common destination and said protocol data units from said at least one further queue share per hop behavior with said protocol data units from said initial scheduling output.

26. An egress interface including a plurality of queues storing protocol data units, where said plurality of queues are organized into sub-divisions, each of said subdivisions comprising a subset of said plurality of queues having a per hop behavior in common, said egress interface comprising:
a first scheduler adapted to produce an initial scheduling output including protocol data units having a common destination, where said protocol data units having said common destination are stored in a subdivision of said plurality of queues; and
a second scheduler adapted to schedule said protocol data units from said initial scheduling output along with protocol data units from at least one further queue, where said protocol data units from said at least one further queue have a destination different from said common destination and said protocol data units from said at least one further queue are predetermined to share a given partition of bandwidth available on a channel with said protocol data units from said initial scheduling output.

27. A computer readable medium containing computer-executable instructions which, when performed by processor in an egress interface storing protocol data units in a plurality of queues, where said plurality of queues are organized into sub-divisions, each of said subdivisions comprising a subset of said plurality of queues having a per hop behavior in common, cause the processor to:
subdivide at least one of said subsets of said queues into a group of queues storing protocol data units having a common destination and at least one further queue storing protocol data units having a differing destination;
schedule said protocol data units from said group of queues to produce an initial scheduling output; and
schedule said protocol data units from said initial scheduling output along with said protocol data units from said at least one further queue.
